(19) United States
(12) Patent Application Publication
(10) Pub. No.: US 2005/0076441 A1
(43) Pub. Date: Apr. 14, 2005

(54) Support apparatus

(75) Inventors: Simon-Paul Dominati, Marseille (FR); Guido Grappiolo, Finale Ligure (Sv) (IT)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Zimmer GmbH, Winterthur (CH)

(21) Appl. No.: 10/959,752

(22) Filed: Oct. 5, 2004

(30) Foreign Application Priority Data
Oct. 6, 2003 (EP) 03 022 402.6

(51) Int. Cl. A61G 13/12

(52) U.S. Cl. 5/621; 5/624

(57) ABSTRACT

The invention relates to a support apparatus for the support of a patient lying in the lateral position at the pelvis having a plurality of support rods, in particular precisely three support rods, which each have a known pre-determined length and which are attached adjustably relative to one another to a common support frame such that different spatial configurations of the probe ends of the support rods facing the patient can be set in use in order to make the spatial position of the support points at which the support rods are supported when used on the patient detectable via the free ends of the support rods opposite to the probe ends and serving as detection ends.

The invention relates to a support apparatus for the support at the pelvis of a patient lying in a lateral position.

In hip joint operations, it is of decisive important for the installation of an artificial hip joint shell that the surgeon orients the shell axis spatially in the correct direction with respect to the pelvis. This applies both to normal surgical techniques and to computer aided surgical techniques (CAS; “computer aided surgery”).

CAS makes it possible to determine the orientation of a bone, for example of the pelvis, in space and to track it during surgery. For this purpose, a tripod is fixed to a probe to be guided by hand by the surgeon, with the free ends of said tripod each being provided e.g. with a sphere. The three spheres define a plane in space whose position can be determined by determining the relative position of the spheres to one another by means of an indication device working with electromagnetic radiation, e.g. infrared radiation.

Single points of a bone can be marked with the tip of the probe, whereby the position of these bone points in space relative to one another can be determined via the detection of the spherical tripod. This procedure is also termed “mapping”. To be able to clearly identify the points on the bone probed by means of the probe, the probed points are aligned on a screen with an image of the bone previously taken by means of computer tomography (CT) or by digitizing carried out by means of a probe at the respective bone. This is necessary since in practice usually only a small region of the total bone is available for the probing of the individual points on the bone and the surgeon is himself not in a position to determine the orientation of the bone in space with reference to these probe points representing only a small region of the total bone. By linking the previously taken CT image with the probed points, however, an identification of the probed points in the CT image and thus a determination of the orientation of the bone in space can take place by means of suitable software. Such systems are also termed navigation systems and the term “CT aided mapping” is also used for this procedure. This is generally known so that it is not intended to go into this in any detail.

It is likewise known to probe specific distinguished points of the bone—to the extent reachable with a probe—without CT while making use of X-ray images in order to determine the spatial position of the bone in this manner.

Despite this support for the surgeon, which is anyway associated with a not unsubstantial technical effort, the determination of the orientation of bones is increasingly made more difficult in that procedures are used more and more in today's surgical techniques which are also small as possible, i.e. in that so-called minimally invasive techniques are used. The actual operation field at which the surgeon can work with the probe during mapping hereby becomes smaller and smaller and the spatial orientation on the patient more and more difficult.

In addition, even when the navigation systems explained above are used, the surgeon still requires a reference plane in order, e.g. in hip joint operations, to derive the correct spatial angle for the axis of the hip joint shell.

The surgeon is ultimately dependent on estimates in this process: in operations with patients lying on their backs, the surgeon assumes that a pelvic plane which is formed by the lateral forwardly projecting tips of the pelvic bone projecting and by the pubic bone is aligned parallel to the support surface of the operating table and that the longitudinal axes of the operating table and of the patient extend parallel to one another. The surgeon derives the spatial angle for the axis of the hip joint shell, including its antetorsion, from this assumed position of the patient. This applies both to the working tools for the acetabulum and to the hip joint shell used later.

In the lateral position, the patent lies on the support surface of the operating table with his healthy side, with an angle being aimed at for the pelvic plane formed from the tips of the pelvic bones and the pubic bone of 90°. For this purpose, the patient is supported on his rear side and on his front side by support constructions which are intended to ensure a safe and immovable position. The surgeon is ultimately also dependent on an estimate in this process, since it is practically impossible for him to determine the position of the mentioned pelvic plane on the patent covered by sterile cloths. The surgeon can only rely on the fact that the angle of the pelvic plane to the support surface of the operating table actually amounts to approximately 90°.

It is therefore the object of the invention to facilitate hip joint operations and in particular to provide a possibility to determine the orientation of the pelvis in space as precisely as possible.

This object is satisfied by the features of claim 1 and in particular in that the support apparatus has a plurality of support rods which each have a known pre-determined length and which are attached adjustably relative to one another to a common support frame such that different spatial configurations of the probe ends of the support rods facing the patient can be set in use in order to make the spatial position of the support points at which the support rods are supported when used on the patient use detectable via the free ends of the support rods opposite to the probe ends and serving as detection ends.

The invention advantageously utilizes the circumstance that the human pelvis has distinguished positions and makes an apparatus available which utilizes these distinguished positions as support points or support positions for rods, i.e. it was recognized in accordance with the invention that certain positions of the human pelvis can be used as predestined positions for the detection of the spatial position of the pelvis. In this process, the distinguished positions of the pelvis are not only used as support points, but the position of the support points is simultaneously moved outwardly away from the pelvis by means of the support rods such that the individual positions can be detected via the detection ends of the support rods and can be evaluated on the basis of the pre-determined known length of the support rods in order to be able in this manner to precisely set the axis position of working tools such as spherical milling cutters relative to the pelvis or the alignment of an artificial hip joint socket.

The support apparatus in accordance with the invention can be secured to an operating table or be a component of an operating table such that the position of the support rods relative to the support surface of the operating table is known during the operation. The adjustability of the support rods allows a punctual probing of the pelvis of the patient, whereby the ends of the support rods can be brought into a spatial configuration which reflects the pelvic anatomy of the patient. By probing pre-determined characteristic points or positions on the pelvis whose relative position is known, the position of the pelvis relative to the support rods and thus to the contact surface of the operating table is clearly determined. When the patient contacts the ends of the support rods with his pelvis via the contact points, the patient is thus not only supported, but the support rods also contain information on the position of the pelvis relative to the contact surface, when the points or positions of the pelvis are known which the ends of the support rods contact.

The information contained in the support rods can advantageously be “read” by means of a navigation system such as was initially described in that the free ends of the support rods remote from the patient are touched by means of the probe supporting the spherical tripod. In this manner, the orientation of the pelvis of the patient in space can be determined via the ends of the support rods remote from the patient from the known length of the support rods and from the known position of the support rods relative to one another.

The invention thus so-to-say allows a remote probing of the pelvis, with the ends of the support rods remote from the patient jointly representing a point-wise mapping of the pelvis which can be used directly for the positional determination of the pelvis when the contact points of the support rods at the pelvis are known. An important advantage of the invention consists of the fact that it permits the carrying out of hip joint operations without CT images of the pelvis having to be taken beforehand. The reason for this is that by touching the ends of the support rods remote from the patient an indirect probing of characteristic points or positions of the pelvis is made possible from which the position of the pelvis in space, in particular relative to the contact surface of the operating table, can be derived directly, i.e. without identification of the probed points in a CT image. This is in particular possible since potential positions on the pelvis lie relatively far apart, which facilitates the orientation determination.

Using the support rods, the surgeon can move to the characteristic points of the pelvis probed through the tissue with his fingers and check their positions. The surgeon is therefore not dependent on exposed regions of the pelvis for the detection of the position of the pelvis. The support rods can therefore be set at characteristic positions of the pelvis which do not first have to be identified at the pelvis with the aid of a CT image. The invention thus makes a CT free mapping possible with which the position of the pelvis in space can be determined unambiguously and with high precision. Particularly with fat patients, it is practically impossible in the lateral position to move with a probe to the pelvic bone at that side at which the patient lies on the operating table when the patient is supported and thus spatially fixed.

A further advantage of the support apparatus in accordance with the invention consists of the fact that not only the inclination of a specific pelvic plane to generally any desired reference system, e.g. to the support surface of the operating table, can be determined, but also the center line in this pelvic plane and its deviation from a plane extending parallel to the support surface of the operating table.

It is furthermore of advantage that the body of the patient can remain completely covered with sterile cloths at the front side since the probing of the pelvis and the setting on of solid support rods can take place with the cloths lying between, i.e. through the cloths. The support apparatus in accordance with the invention thus does not have to penetrate into the sterile region.

With the aid of the invention, the surgeon or a mapping system can gain an impression at any time during the operation of how the pelvis of the patient is oriented in space.

It is expressly pointed out at this point that the support apparatus in accordance with the invention can also advantageously be used without a mapping system or navigation system. By the selection of suitable contact points on the pelvis, the surgeon can also gain an impression of the position of the pelvis in space in that he simply places a plate at the ends of the support rods remote from the patient whose orientation in space reflects the pelvic orientation and thus makes it visible to the surgeon.

Advantageous embodiments of the invention are recited in the dependent claims, in the description and in the drawing.

As already stated in the above, the support rods are preferably made for the probing of the pelvic anatomy, in particular for the probing of pre-determined points or positions on the pelvis, with the characteristic points or positions preferably defining an anterior pelvic plane which extends at least approximately perpendicular to the median sagittal plane.

The lateral, forwardly projecting tips of the pelvic bones and the pubic bone preferably serve as contact points or probe points or contact positions or probe positions. A pelvic plane fixed by these three points extends perpendicular to the median sagittal plane of the patient. These characteristic points of the pelvis are particularly suitable for determining the pelvic orientation such that the support apparatus in accordance with the invention preferably has precisely three support rods.

A simple adaptation of the support apparatus to different physical circumstances is achieved when, in accordance with a further preferred embodiment, the ends of the support rods are each provided with a replaceable pressure piston or support foot. A plurality of sets of differently sized pressure pistons can be provided, in particular a plurality of sets of pressure pistons with differently sized support surfaces.

Provision can furthermore be made for the support rods each to be adjustable relative to the support frame in the direction of their longitudinal extents. The effective length of the support rods, i.e. the spacing between the support frame and the patient, can hereby be changed in a simple manner.

Provision is made in a particularly preferred embodiment for the support rods to extend parallel to one another and to have the same length. A conclusion can hereby be drawn on the orientation of the pelvis relative to the support frame and thus to the operating table directly from the position of the ends of the support rods remote from the patient, since the free ends of the support ends jointly represent a direct map of the pelvis with respect to the characteristic points or positions at which the probe ends of the support rods contact the patient. The plane fixed by the contact points at the pelvis is so-to-say offset in parallel along the support rods away from the patient. The orientation of this pelvic plane in space can be “read off” at the free ends of the support rods.

The support rods can be adjustable relative to one another in two directions perpendicular to one another.

Provision is preferably made for each support rod to be attached to a support arm extending perpendicular to the support rod, with the support arms being attached to a common support which extends perpendicular both to the support rods and to the support arms.

A rigid spatial configuration can be established by means of fixing devices.

Provision can in particular be made for the support rods to be fixable to the support arms and/or for the support arms to be fixable to the support in each case by clamping tight.

The invention moreover relates to an operating table having at least one support surface for a patient and having a support apparatus in accordance with the invention such as was described above.

The support apparatus can be releasably attachable to the operating table or be a component of the operating table.

The support rods preferably extend approximately parallel to the contact surface of the operating table.

Provision is furthermore preferably made for the support rods to be adjustable relative to one another in directions extending parallel and perpendicular to the support surface.

It is furthermore proposed in accordance with the invention that a patient lying on the support surface can be clamped between the support apparatus and a counter-holding device attached to the operating table. It is hereby ensured that the patient lying on the support surface is held immovably between the support apparatus and the counter-holding device. The counter-holding device can be a separate apparatus which can be releasably attached to the operating table or is a component of the operating table. It is basically also possible to integrate the support apparatus in accordance with the invention and a counter-holding device into a single apparatus which is either releasably attachable to the operating table or forms a component of the operating table.

The counter-holding device can include at least one support cushion or support pad which is preferably made such that it can be brought into contact in the region of the lumbar vertebrae above the patient's buttocks.

The invention furthermore relates to an operating system having at least one support apparatus or one operating table in accordance with any one of the preceding claims and having a detection device for the determination of the spatial position of the pelvis of the patient via the detection ends of the support rods of the support apparatus, with the detection device having a probe device with a probe by means of which the detection ends of the support rods can be probed, and having an indication device which includes a transmitter, a receiver and an evaluation unit and by means of which the spatial position of at least one probe tip of the probe, in particular additionally the spatial position of an axis extending through the probe tip, can be determined via electromagnetic radiation, in particular infrared radiation, transmitted via the transmitter, reflected by the probe and received by means of the receiver.

The invention will be described in the following by way of example with reference to the drawing. There are shown:

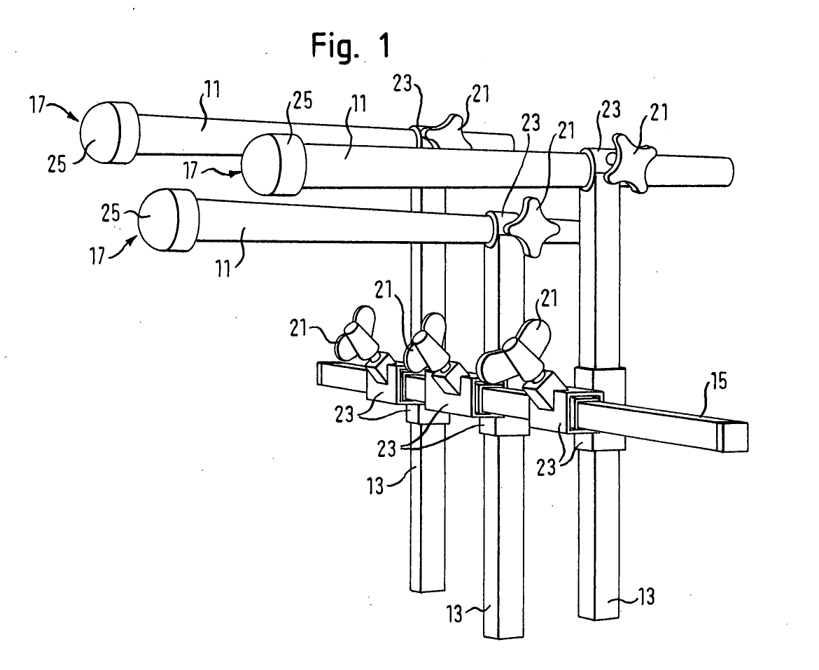

FIG. 1 a perspective view of a support apparatus in accordance with an embodiment of the invention;

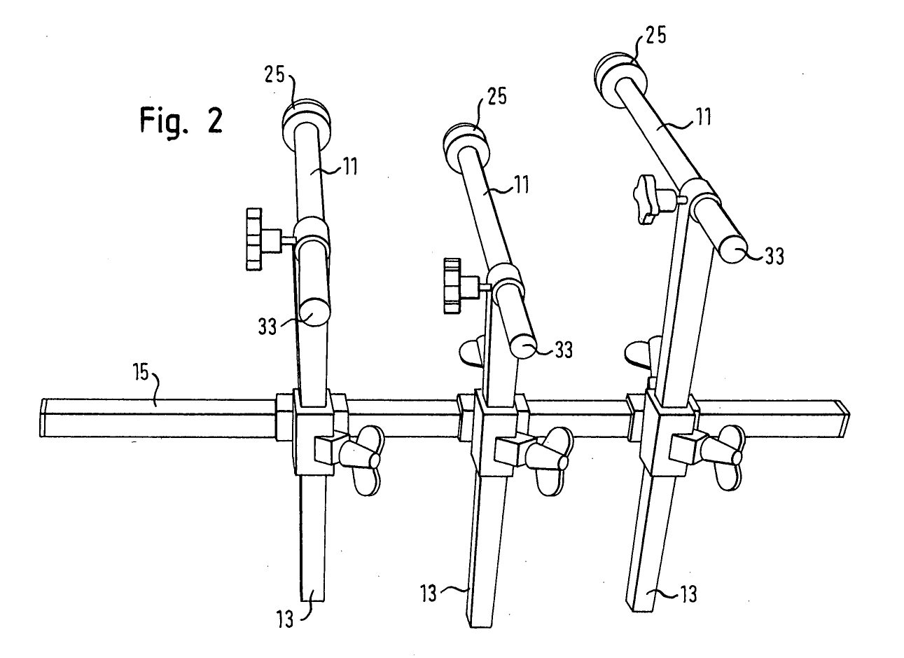

FIG. 2 the support apparatus of FIG. 1 in another perspective view; and

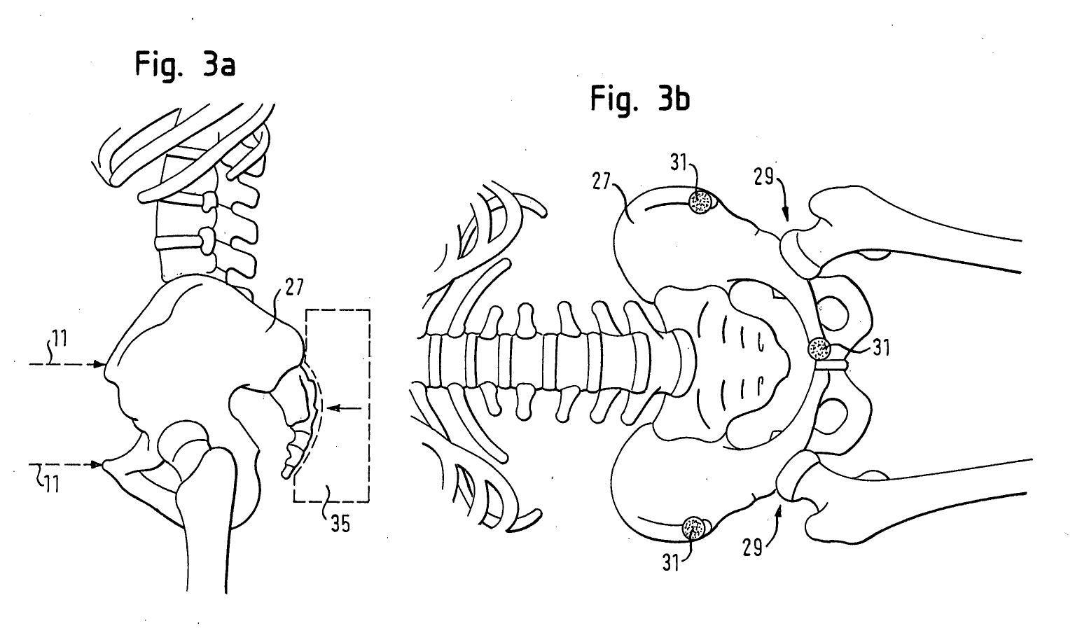

FIGS. 3a, 3b different views of a human pelvis in which the possible contact points for the support apparatus in accordance with the invention have been drawn.

The support apparatus in accordance with the invention shown in FIGS. 1 and 2 includes a support frame with a common support 15 for three parallel support arms 13 which are each connected to the support 15 by a connector including two guides 23 extending at right angles to one another.

The sleeve-like guides 23 formed in accordance with the here square cross-section of the support 15 and of the support arms 13 are pushed onto the respective support element 15, 13. The support elements 15, 13 can be fixedly clamped to the respective guide 23 by means of a fixing device 21 including a wing screw such that overall a rigid spatial construction can be created.

When the fixing devices 21 are released, the connectors, and thus the support arms 13, are displaceable along the support 15, whereby the spacings of the support arms 13 extending parallel to one another can be set with respect to one another.

The support arms 13 are each provided at their one free end with a guide 23 which has a circular cross-section in corresponding to the circular cross-section of a support rod 11, which can be inserted through the guide 23 and can be fixed to the guide 23 and thus to the support arm 13 by means of a fixing device 21 including a fixing screw.

The support apparatus in accordance with the invention including the support 15, the support arms 13 and the support rods 11 can thus ought by means of a total of nine fixing devices 21 into a rigid total construction in which—as in a Cartesian coordinate system—the support arms 13 extend perpendicular to the support 15 and the support rods 11 extend perpendicular to both the support arms 13 and to carrier 15.

On one side of the support rods 11, their free ends serving as probe ends 17 during the operation are each provided with a pressure piston 25, also designated a support foot in the following, in the form of a mountable cap. The contact surface to be brought into contact with the patient can be brought to practically any size, also a size differing from the size of the cross-sectional surface of the respective support rod 11 by means of these support feet 25. In this manner, the size of the support surface of the support feet 25 can be directly matched to the respective patient and in particular to the thickness of the fat tissue of the patient. The thicker the fat tissue is, the smaller the support surface of the pressure piston 25 is selected in order to be able to reach the respectively desired contact point on the pelvis of the patient.

The attachment of the support apparatus in accordance with the invention to an operating table takes place, for example, via the support 15 by means of fixing devices and/or clamping devices (not shown) such that the support rods 11 extend parallel to the support surface of the operating table. Since the support rods 11 have the same length, the ends 33 (FIG. 2) of the support rods 11 remote from the patient during the operation form a plane whose position in space agrees with the spatial position of that plane which is defined by the three contact points at the pelvis of the patient, i.e. this pelvic plane is so-to-say projected out of the patient.

FIGS. 3a and 3b show the pelvis 27 of a patient adopting a lateral position with reference to a partly shown skeleton, with FIG. 3a showing a plan view from above, i.e. perpendicular to the support surface of the operating table, and FIG. 3b showing a side view, i.e. parallel to the support surface of the operating table.

Preferred contact points 31 on the anterior side of the pelvis 27 are located, in accordance with FIG. 3b at the pubic bone and in the region of the forwardly projecting lateral tips of the pelvis 27. A perpendicular orientation of the pelvic plane defined by the three contact points 31 can be ensured relative to the support surface of the operating table with the aid of the support rods 11 which are only shown schematically in FIG. 3a and whose pressure pistons 25 contact these positions 31.

A support of the patient from behind takes place by a counter-holding device 35 only indicated schematically in FIG. 3a in the form of a pad or of a cushion which is likewise attached to the operating table such that the patient is immovably fixed between the support rods 11, on the one side, and the counter-holding device 35, on the other side, as is indicated by the arrows in FIG. 3a.

The procedure on the use of the support apparatus in accordance with the invention as part of a hip joint operation is as follows:

The patient is first provisionally supported in the lateral position such that the pelvic plane to be subsequently probed by means of the support rods 11 includes as precisely as possible an angle of 90° with the support surface of the operating table. Subsequently, the outer regions of the patient are covered with sterile cloths. The patient is still manually supported in this process.

The three pressure pistons 25 of the support rods 11 are subsequently guided to the three contact points 31 in that the support arms 13 are displaced along the support 15 and the support rods 11 are displaced in the direction of their longitudinal axis relative to the support arms 13. In this process, the position of the pressure pistons 25 with respect to the desired contact points 31 are probed and controlled through the sterile cloths and through the tissue of the patient.

More or less simultaneously, the counter-holding device 35, e.g. a pressure cushion, is moved on from the rear above the buttocks, whereby the contact points 31 of the pelvis 27 are pressed onto the support feet 25.

Since the support rods 11 have the same length in the embodiment described here, the pelvic plane defined by the three contact points 31 can be read off or probed in parallel displacement at the free ends 33 of the support rods 11 remote from the patient. This can be—but does not have to be—carried out with the aid of a CT-free mapping method using an indication device, as was explained above.

The surgeon now knows the spatial orientation of the pelvis 27 relative to the support surface of the operating table such that, starting from this, the correct spatial angle for the axis of a spherical milling cutter or of a hip joint shell of the hip joint 29 to be operated on (FIG. 3) can be safely and reliably derived.

### Reference Symbol List

11 support rod
13 support arm
15 support
17 probe end
21 fixing device
23 guide
25 pressure piston, support foot
27 pelvis
29 hip joint
31 contact point
33 free end of the support rod, detection end
35 counter-holding device.

1. A support apparatus for the support of a patient lying in the lateral position at the pelvis having a plurality of support rods (11), in particular precisely three support rods (11), which each have a known pre-determined length and which are attached adjustably relative to one another to a common support frame (13, 15) such that different spatial configurations of the probe ends (17) of the support rods (11) facing the patient can be set in use in order to make the spatial position of the support points at which the support rods (11) are supported when used on the patient detectable via the free ends (33) of the support rods (11) opposite to the probe ends (17) and serving as detection ends.

2. A support apparatus in accordance with claim 1, characterized in that the support rods (11) are made for the probing of the pelvic anatomy.

3. A support apparatus in accordance with claim 1, characterized in that the support rods (11) are made for the probing of pre-determined characteristic points or positions (31) on the pelvis (27), in particular on the anterior side of the pelvis, with the characteristic points or positions (31) preferably defining an anterior pelvic plane which preferably extends at least approximately perpendicular to the median sagittal plane.

4. A support apparatus in accordance with claim 1, characterized in that the support rods (11) are made such that the pelvis (27) of the patient can be mapped by means of the support rods (11) with respect to pre-determined characteristic points or positions (31) on the pelvis (27), in particular on the anterior side of the pelvis (27).

5. A support apparatus in accordance with claim 1, characterized in that the probe ends (17) of the support rods (11) are each provided with a replaceable pressure piston or support foot (25).

6. A support apparatus in accordance with claim 5, characterized in that a plurality of sets of differently sized pressure pistons or support feet (25) are provided.

7. A support apparatus in accordance with claim 1, characterized in that the support rods (11) are each adjustable relative to the support frame (13, 15) in the direction of their longitudinal extents.

8. A support apparatus in accordance with claim 1, characterized in that the support rods (11) extend parallel to one another.

9. A support apparatus in accordance with claim 1, characterized in that the support rods (11) have the same length.

10. A support apparatus in accordance with claim 1, characterized in that the support rods (11) each have a circular cross-section.

11. A support apparatus in accordance with claim 1, characterized in that the support rods (11) are adjustable relative to one another in two directions standing perpendicular to one another.

12. A support apparatus in accordance with claim 1, characterized in that each support rod (11) is attached to a support arm (13) extending perpendicular to the support rod (11), with the support arms (13) being attached to a common support (15) which extends perpendicular both to the support rods (11) and to the support arms (13).

13. A support apparatus in accordance with claim 12, characterized in that the support rods (11) are fixable to the support arms (13) and/or the support arms (13) are fixable to the support (15) in each case by clamping tight in guides (23).

14. A support apparatus in accordance with claim 1, characterized in that a rigid spatial configuration can be established by means of fixing devices (21).

15. A support apparatus in accordance with claim 1, characterized in that the support frame (13, 15) can be fastened to an operating table.

16. A support apparatus in accordance with claim 1, characterized in that the support frame (13, 15) is a component of an operating table.

17. An operating table having a support surface for a patient and having at least one support apparatus for the support of the patient lying in the lateral position at the pelvis, the support apparatus having a plurality of support rods (11), in particular precisely three support rods (11), which each have a known pre-determined length and which are attached adjustably relative to one another to a common support frame (13, 15) such that different spatial configurations of the probe ends (17) of the support rods (11) facing the patient can be set in use in order to make the spatial position of the support points at which the support rods (11) are supported when used on the patient detectable via the free ends (33) of the support rods (11) opposite to the probe ends (17) and serving as detection ends.

18. An operating table in accordance with claim 17, characterized in that the support apparatus can be releasably attached to the operating table.

19. An operating table in accordance with claim 17, characterized in that the support apparatus is a component of the operating table.

20. An operating table in accordance with claim 17, characterized in that the support rods (11) extend approximately parallel to the support surface.

21. An operating table in accordance with claim 17, characterized in that the support rods (11) are adjustable relative to one another in directions extending parallel and perpendicular to the support surface.

22. An operating table in accordance with claim 17, characterized in that a patient lying on the support surface can be clamped between the support apparatus and a counter-holding device (35) attached to the operating table.

23. An operating table in accordance with claim 22, characterized in that the counter-holding device (35) includes at least one support cushion or support pad.

24. An operating system having at least one support apparatus for the support of a patient lying in the lateral position at the pelvis having a plurality of support rods (11), in particular precisely three support rods (11), which each have a known pre-determined length and which are attached adjustably relative to one another to a common support frame (13, 15) such that different spatial configurations of the probe ends (17) of the support rods (11) facing the patient can be set in use in order to make the spatial position of the support points at which the support rods (11) are supported when used on the patient detectable via the free ends (33) of the support rods (11) opposite to the probe ends (17) and serving as detection ends, the operating system further having a detection device for the determination of the spatial position of the pelvis of the patient via the detection ends (33) of the support rods (11) of the support apparatus, with the detection device having a probe device with a probe by means of which the detection ends (33) of the support rods (11) can be probed, and having an indication device which includes a transmitter, a receiver and an evaluation unit and by means of which the spatial position of at least one probe tip of the probe, in particular additionally the spatial position of an axis extending through the probe tip, can be determined via electromagnetic radiation, in particular via infrared radiation, transmitted via the transmitter, reflected from the probe and received by means of the receiver.

25. An operating system having an operating table having a support surface for a patient and having at least one support apparatus for the support of the patient lying in the lateral position at the pelvis, the support apparatus having a plurality of support rods (11), in particular precisely three support rods (11), which each have a known pre-determined length and which are attached adjustably relative to one another to a common support frame (13, 15) such that different spatial configurations of the probe ends (17) of the support rods (11) facing the patient can be set in use in order to make the spatial position of the support points at which the support rods (11) are supported when used on the patient detectable via the free ends (33) of the support rods (11) opposite to the probe ends (17) and serving as detection ends, the operating system further having a detection device for the determination of the spatial position of the pelvis of the patient via the detection ends (33) of the support rods (11) of the support apparatus, with the detection device having a probe device with a probe by means of which the detection ends (33) of the support rods (11) can be probed, and having an indication device which includes a transmitter, a receiver and an evaluation unit and by means of which the spatial position of at least one probe tip of the probe, in particular additionally the spatial position of an axis extending through the probe tip, can be determined via electromagnetic radiation, in particular via infrared radiation, transmitted via the transmitter, reflected from the probe and received by means of the receiver.
